(19) United States
(12) Patent Application Publication
(10) Pub. No.: US 2015/0014901 A1
(43) Pub. Date: Jan. 15, 2015

(54) METHOD FOR MANUFACTURING NON-SEWING THREE-DIMENSIONAL FABRIC CAPABLE OF POLYCHROME PRINTING

(71) Applicant: NOVA LEATHER ENTERPRISES Co. LTD., Taichung (TW)

(72) Inventor: SU-FANG OU, New Taipei (TW)

(73) Assignee: NOVA LEATHER ENTERPRISES Co. LTD., Taichung (TW)

(21) Appl. No.: 13/937,352

(22) Filed: Jul. 9, 2013

(51) Int. Cl. B29C 51/00; B29C 51/10; B28B 7/34

(52) U.S. Cl. CPC B29C 51/004; B28B 7/346; B29C 51/10
USPC 264/628

(57) ABSTRACT

A method for manufacturing non-sewing three-dimensional fabric capable of polychrome printing comprises steps of setting a mold seat formed by a stack of layers of mold powder, reversely pressing a surface layer thereof by a substantial fabric to form a plurality of low-lying grooves corresponding to the patterns, sintering the mold seat under high temperature for getting a ventilative mold plate, and placing and positioning the mold plate in a vacuum suction groove, whereby a half-melted plastic fabric plastered on a top surface of the ventilative mold plate is tightly pressed on a surface of the low-lying grooves by a vacuum suction force and plastic-formed into an initial material with corresponding reverse and three-dimensional patterns.

### BACKGROUND OF THE INVENTION

1. Field of the Invention

A method for manufacturing non-sewing three-dimensional fabric capable of polychrome printing provides a method provides a substantially sewed vamp or fabric able to be remanufactured according to an original size of a forming mold for conveniently and precisely manufacturing a distribution of the required three-dimensional shapes and patterns and being partially or fully pre-printed by matching with a plastic fabric, thereby being precisely matched and positioned with the three-dimensional patterns while being sucked. The printed sheet matches with a plurality of low-lying grooves, thereby synchronously forming the imitated fabrics of the three-dimensional patterns and the polychrome surfaces of the vamp or fabric.

2. Description of the Related Art

A conventional method of vamps or other fabrics, such as a purse, a shoulder bag, and a belt, are mostly distributed by patterns in order to attain the variations of an apparent difference or an expression of the trademark or the characteristic. To show the conventional patterns, not only a material with basic grains is adopted, a pre-cut graphic block is also adopted to form a stack of layers exceeded the thickness in three-dimensional on the vamp or fabric by sewing or laminating, thereby attaining a three-dimensional vision of the vamp or fabric with a better printing effect.

However, the conventional method utilizing sewing and laminating graphic blocks for processing the vamp is quite complicated in the preparing and processing steps, and occupies a great dependence of labor and place. The costs of labor and working hour can not be reduced, thereby directly affecting the output ability of the producing line.

The conventional method utilizing sewing and laminating the graphic blocks for processing the vamp of fabric requires a high processing precision. If the operator is inexperienced or inattentive, the product defect, such as crooked sewing or peeled part of the product, may cause a serious effect of the product management.

### SUMMARY OF THE INVENTION

It is an object of the present invention to provide a method for manufacturing non-sewing three-dimensional fabric capable of polychrome printing. The method provides a substantially sewed vamp or fabric that so as to be remanufactured according to the original size of a forming mold and then reversely sucked for producing an excellent imitated vamp or fabric with the three-dimensional shapes and patterns distributed as good as the expected vamp or fabric.

It is a further object of the present invention to provide a method for a forming mold of a three-dimensional shoe fabric. The forming mold forms a bottom mold seat by a stack of layer of mold powders, such as ceramic powders, which have a coarse bottom layer and a fine surface layer. A top side of the surface layer is reversely pressed by a substantial vamp or fabric in order to form a plurality of low-lying grooves corresponding to the patterns of the vamp or fabric. The bottom mold seat formed with the low-lying grooves is able to be sintered under high temperature for getting a hard ventilative mold plate with a flat surface which has a distribution of overall and micro-ventilation interstices and comprises a reverse-shaped low-lying part of the vamp or fabric. The ventilative mold plate is placed in a vacuum suction groove for combining and positioning. A forming assembly for forming a plastic fabric includes multi effects of conveniently and quickly forming the mold and low cost of manufacture.

It is a further object of the present invention to provide a method for conveniently manufacturing and processing a three-dimensional shoe fabric. The ventilative mold plate is placed in the fabric forming assembly combining and positioning to a vacuum suction grove for allowing a plastic fabric pre-baked into half-melted state to be plastered on a top surface of the ventilative mold plate and a bottom surface of the plastic fabric to be tightly pressed on a surface of a low-lying part by a downward vacuum suction force of the suction groove, thereby plastic-forming an initial material distributed by a plurality of reverse three-dimensional patterns corresponding to the patterns of the low-lying part of the ventilative mold plate, and then removing redundant side scraps of the initial material to complete a manufacture of the vamp or fabric. Such a simplified processing provides a fast manufacture of the imitated fabric as same as the three-dimensional patterns of the substantial vamp or fabric, which provides practicability and economic benefits for high manufacture efficiency, precise product size, and great reduction of the manufacturing cost.

It is a further object of the present invention to provide A method for manufacturing non-sewing three-dimensional fabric capable of polychrome printing. The plastic fabric is preferably manufactured as partial or full printing so as to be positioned and matched with the three-dimensional patterns while being processed in vacuum suction. The printed sheet is disposed to cooperate with the low-lying grooves, thereby completing the imitated fabric as same as three-dimensional patterns and polychromatic surfaces of the substantial vamp and the fabric after cooling and shaping the initial material, and then removing the redundant side scraps thereof for greatly reducing the manufacture cost.

### BRIEF DESCRIPTION OF THE DRAWINGS

FIG. 1 is a perspective view showing a shoe body;

FIG. 1a is an exploded view showing a substantial vamp;

FIG. 1b is a schematic view showing the substantial vamp in combination;

FIG. 2 is a perspective view showing a bottom mold seat;

FIG. 2a is an enlarged view showing a part of FIG. 2;

FIG. 2b is a perspective view showing a relation between a ventilative mold plate and a suction groove;

FIG. 2c is a perspective view showing a relation between the suction groove and a fabric;

FIG. 3a is a first sectional view showing a forming process of an initial material;

FIG. 3b is a second sectional view showing a forming process of the initial material;

FIG. 3c is a third sectional view showing a forming process of the initial material;

FIG. 4 is a schematic view showing a finished product of the initial material;

FIG. 4a is an exploded view showing a finished product of an imitated fabric;

FIG. 5 is a perspective view showing the imitated fabric while being disposed on a shoe body; and

FIG. 5a is a schematic view showing the imitated fabric.

### DETAILED DESCRIPTION OF THE PREFERRED EMBODIMENTS

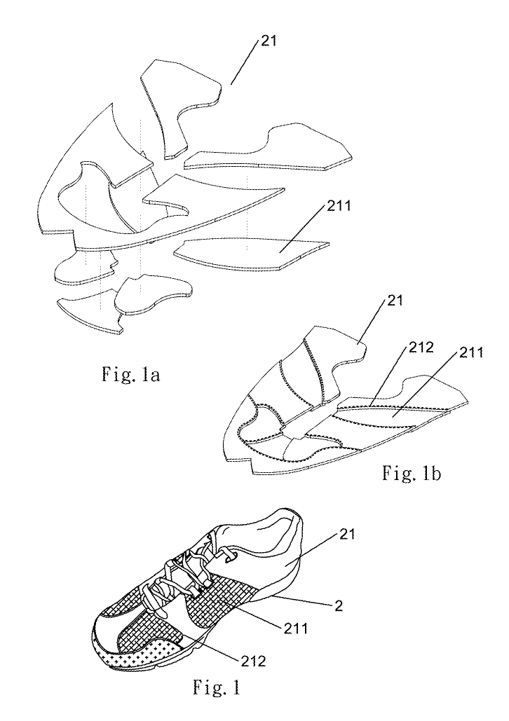

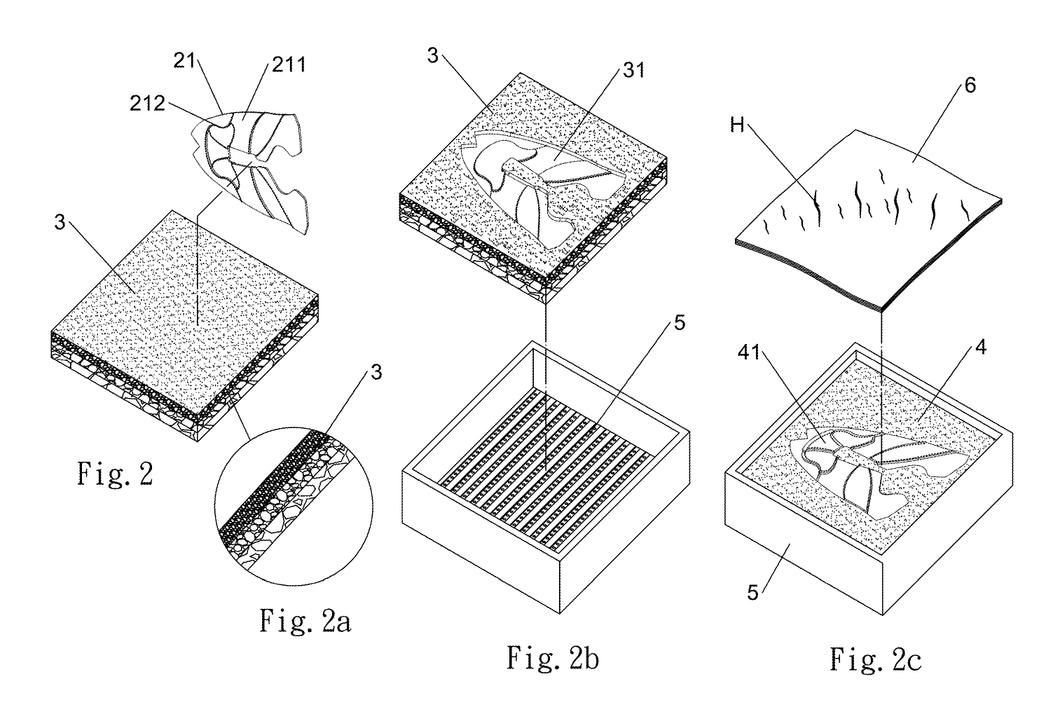

Referring to FIGS. 1, 1a, 1b and 2, a preferred embodiment of the present invention is shown: A plurality of substantial laminated graphic blocks 211 of a shoe body 2 are sewed or appliquéd by a substantial sewing 212 for manufacturing a vamp 21 so as to directly remanufacture according to an original size of a forming mold, thereby attaining a simplified method for conveniently and precisely manufacturing the shoe or other fabrics distributed by the required three-dimensional shapes and patterns.

Referring to FIGS. 2 and 2a: the forming mold of the present invention forms a bottom mold seat 3 by a stack of layers of mold powders which have a coarse bottom layer and a fine surface layer. The mold powders are preferably adopted by a ceramic powder.

Referring to FIG. 2b, a top side of the surface layer of the bottom mold seat 3 reversely pressed by the substantial vamp 21 is shown: A low-lying groove 31 is formed corresponding to the patterns of the vamp 21. The bottom mold seat 3 with the low-lying groove 31 is sintered under high temperature for getting a hard ventilative mold plate 4 with a flat surface which includes a distribution of overall and micro-ventilation interstices and comprises a reverse-shaped low-lying part 41 of the vamp 21.

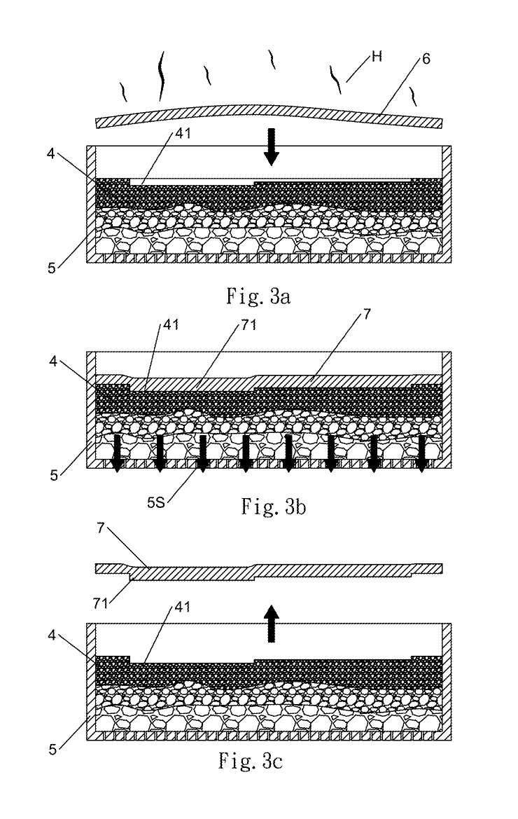

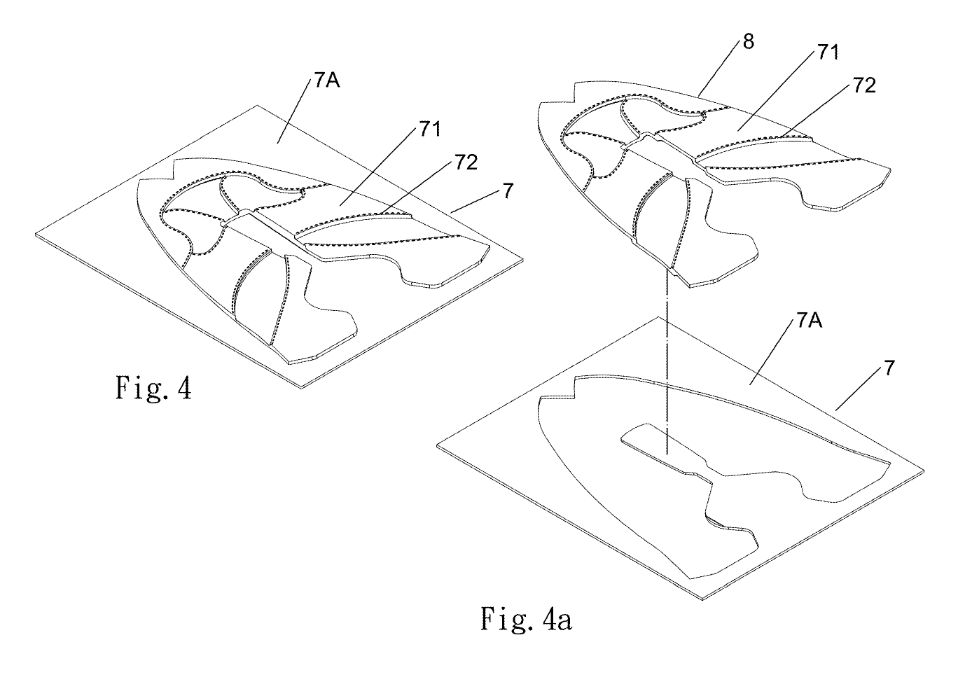

Referring to FIGS. 2c and 3a: The ventilative mold plate 4 is placed in a vacuum suction groove 5 for combining and positioning, which allows a plastic fabric 6 pre-baked H into half-melted state to be plastered on a top surface of the ventilative mold plate 4 as shown in FIG. 3-B and a bottom surface of the plastic fabric 6 to be tightly pressed on a surface of the low-lying part 41 by a downward suction force 5S of the vacuum suction groove 5, thereby plastic-forming an initial material 7 distributed by a plurality of reverse three-dimensional patterns corresponding to the patterns of the low-lying part 41 of the ventilative mold plate 4 as shown in FIGS. 3b, 3c, and 4.

The initial material 7 includes a three-dimensional layer surface distributed by a protuberated embossed surface 71 corresponding to the low-lying part 41. Further, tiny imitated sewing 72 is also correspondingly protuberated.

Referring to FIG. 4a: A redundant side scraps of the initial material is removed to complete a manufacture of an imitated fabric 8 as same as a shape and the three-dimensional patterns of the substantial vamp 21.

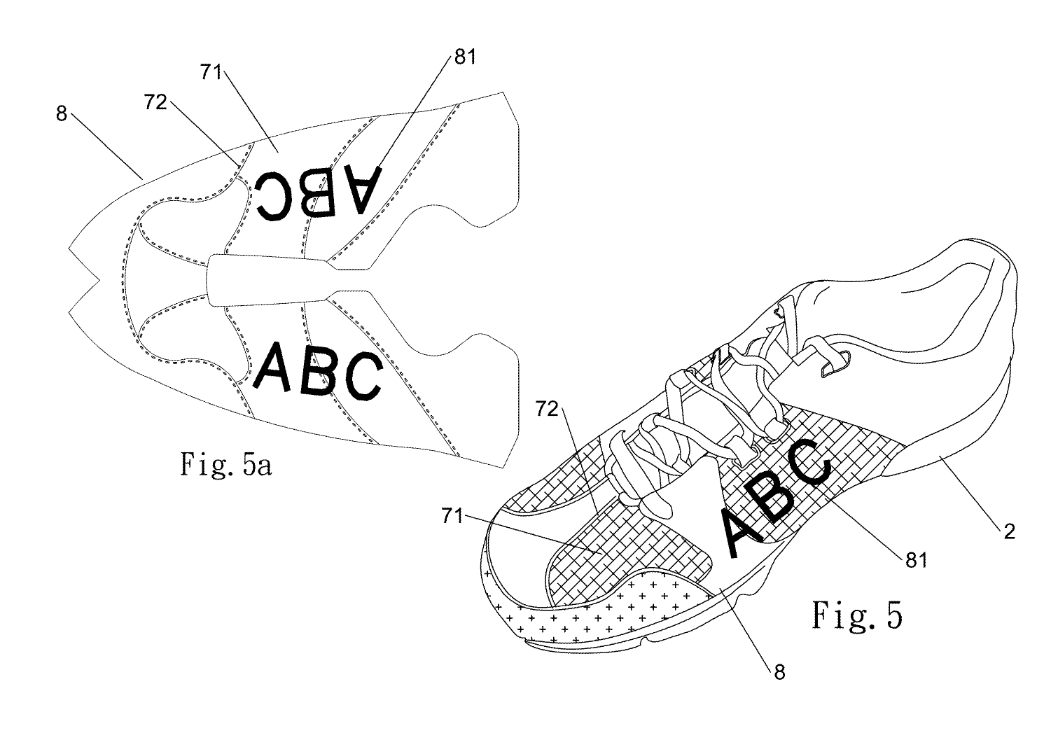

Referring to FIGS. 5 and 5a: The imitated fabric 8 is formed into a laminated sheet, a surface of which is reprocessed into a different appearance by embossed-surface 71 coloring, word-adding, pattern-printing, etc. before being combined with a show body 2 for attaining a product variety.

Referring to FIG. 4: The plastic fabric 6 is partially or fully pre-printed in polychrome according to a demand of figures and colors of a part of shoe shape before being processed so as to match with the three-dimensional patterns during the vacuum suction processing. A printing sheet is disposed to cooperate with the low-lying grooves, thereby completing the imitated fabric as same as the three-dimensional patterns and polychromatic surfaces of the substantial vamp and the fabric after cooling and shaping the initial material, and then removing the redundant side scraps thereof.

By way of the method for an integrated manufacture, a three-dimensional vamp with non-sewing is manufactured like the real sewing and has patterns with polychrome surfaces.

I claim:

1. A method for manufacturing non-sewing three-dimensional fabrics capable of polychrome printing comprising steps of forming a bottom mold seat by a stack of layers of mold powders having a coarse bottom layer and a fine surface layer; reversely pressing a top side of said surface layer of said bottom mold seat by a substantial vamp or fabric for forming a plurality of low-lying grooves corresponding to a plurality of patterns of said vamp or fabric; sintering said bottom mold seat with said low-lying grooves under high temperature for getting a hard ventilative mold plate with a flat surface having a distribution of overall and micro-ventilation interstices and comprising a reverse-shaped low-lying part of said vamp or fabric; placing said ventilative mold plate in a vacuum suction groove for combing and positioning, which allows a plastic fabric pre-baked into half-melted state to be plastered on a top surface of said ventilative mold plate and a bottom surface of said plastic fabric to be tightly pressed on a surface of said low-lying part by a downward vacuum suction force of said suction groove, thereby plastic-forming an initial material distributed by a plurality of reverse three-dimensional patterns corresponding to said patterns of said low-lying part of said ventilative mold plate; and cooling and shaping said initial material, and then removing redundant side scraps of said initial material to complete a manufacture of an imitated fabric as same as a shape and said three-dimensional patterns of said substantial vamp and said fabric.

2. The method for manufacturing non-sewing three-dimensional fabric capable of polychrome printing as claimed in claim 1, wherein said mold powders are adopted by ceramic powers.

3. The method for manufacturing non-sewing three-dimensional fabric capable of polychrome printing as claimed in claim 1, wherein said imitated fabric is formed into a laminated sheet, a surface of which is reprocessed into a different appearance by embossed-surface coloring, word-adding, pattern-printing, etc. before being combined with a shoe body.

4. The method for manufacturing non-sewing three-dimensional fabric capable of polychrome printing as claimed in claim 1, wherein said plastic fabric is partially or fully pre-printed in polychrome according to a demand of figures and colors of a part of shoe shape before being processed so as to match with said three-dimensional patterns during said vacuum suction processing; a printed sheet being disposed to cooperate with said low-lying grooves, thereby completing said imitated fabric as same as said three-dimensional patterns and polychromatic surfaces of said substantial vamp and said fabric after cooling and shaping said initial material, and then removing said redundant side scraps thereof.
